(19) United States
(12) Patent Application Publication
(10) Pub. No.: US 2026/0309261 A1
(43) Pub. Date: Oct. 8, 2026

(54) QUICK-RELEASE HOSE COUPLING FOR AT LEAST ONE HOSE

(71) Applicant: GEA FARM TECHNOLOGIES GMBH, Bönen (DE)

(72) Inventors: Magnus WIETHOFF, Welver (DE); Benedikt SCHÜRMANN, Nottuln (DE)

(21) Appl. No.: 19/118,465

(22) PCT Filed: Sep. 29, 2023
(86) PCT No.: PCT/EP2023/077097

§ 371 Date: Apr. 4, 2025

(30) Foreign Application Priority Data
Oct. 6, 2022 (DE) 10 2022 125 845.9

(51) Int. Cl. F16L 37/56; A01J 5/04; F16L 37/127; F16L 37/18

(52) U.S. Cl. CPC F16L 37/56; A01J 5/044; F16L 37/127; F16L 37/18

(57) ABSTRACT

A quick-release hose coupling connects and disconnects at least two line ends of lines for liquid or gaseous media, of which at least one is an elastic hose. The coupling has first and a second connectable coupling parts. The first coupling part has at least one protruding pipe socket as the line end. The second coupling part has the at least one hose as the line end, into which a tubular insert is inserted at the end. When the coupling parts are coupled, the at least one pipe socket of the first coupling part is guided through the insert of the second coupling part and projects beyond the insert in the hose direction. A sealing surface is formed between an outer lateral surface of the at least one pipe socket and an inner surface of the at least one hose.

### BACKGROUND AND SUMMARY OF THE INVENTION

Exemplary embodiments of the invention relate to a quick-release hose coupling for connecting and disconnecting at least two line ends of lines for liquid or gaseous media, of which at least one is an elastic hose, with a first coupling part and a second coupling part that can be mechanically coupled to one another.

A hose coupling is used to connect or disconnect a hose at a connection point. If this can be done quickly and without tools, it is referred to as a quick-release hose coupling.

Such quick-release hose couplings are also used in milking machines, for example to connect and disconnect the milk hoses from a milking cluster at the milking parlor or from another milk collection device. A quick-release hose coupling for a milking cluster is preferably designed so that several hose connections can be opened or disconnected simultaneously, for example four milking hoses for the four teats of a cow's udder, as well as one or more vacuum and/or cleaning agent lines. In this regard, food regulatory requirements are to be taken into account, for example, the quick-release hose couplings are to be designed in such a way that no dead spaces, or only the smallest possible dead spaces, in which milk residues can collect, arise.

A milk hose coupling is known, for example, from the publication WO 2007/098 959 A1. In this coupling, two coupling parts are connected to each other by cooperating locking means. At least one coupling part has a seal that seals a passage of the coupling parts to the outside. Furthermore, at least one of the two coupling parts is designed so that a milk hose can be placed on a pipe socket and clamped on the pipe socket by means of a cap nut. However, the arrangement is only suitable for a single hose—a quick-release coupling in which several hoses can be connected or disconnected at the same time is not disclosed in the document and cannot be implemented with the described coupling principle of the two coupling parts.

Exemplary embodiments of the present invention are directed to a quick-release hose coupling of the type mentioned at the beginning that can be used in a simple way to connect or disconnect several hoses simultaneously and in whose passage for the medium dead spaces are avoided as far as possible.

A quick-release hose coupling according to the invention is characterized in that the first coupling part has at least one protruding pipe socket as the end of the line, and the second coupling part has the at least one hose as the end of the line, into which a tubular insert is inserted at the end, wherein, when the coupling parts are coupled, the coupled coupling parts, the at least one pipe socket of the first coupling part is guided through the insert of the second coupling part and projects beyond the insert in the hose direction, and a sealing surface is formed between an outer lateral surface of the at least one pipe socket and an inner surface of the at least one hose.

According to the invention, the hose to be connected or disconnected by the hose coupling itself provides the seal to the other end of the line, which is formed by a pipe socket. This eliminates the need for an additional seal that would require maintenance or regular replacement. In addition, further potential dead volumes in the area of a separate seal are avoided. The insert simplifies the insertion of the pipe socket into the hose end. By matching the lengths of the insert and the pipe socket, the pipe socket still reaches the material of the hose, allowing a seal to be made.

In an advantageous embodiment of the quick-release hose coupling, an inner diameter of the insert is reduced in the hose direction. The insert is thereby funnel-shaped, which facilitates the introduction of the pipe socket. In addition, centering is achieved when the two coupling parts are joined together in a not quite correct alignment. Another advantage is that the outer diameter of the insert in the hose direction is also reduced. This allows the insert to clamp firmly in the hose, or the hose to sit more firmly on the insert.

In a further advantageous embodiment of the quick-release hose coupling, the insert has an outwardly projecting collar at its end pointing against the hose direction. This forms a stop for the hose and prevents the insert from being pushed into the hose by the pipe socket. Furthermore and preferably, a wall thickness of the insert decreases towards its end pointing in the hose direction. A step at the transition between the end of the insert and the hose is thus kept as small as possible, thereby preventing the possible accumulation of dirt.

In a further advantageous embodiment of the quick-release hose coupling, the second coupling part has at least one grommet for receiving the end of the at least one hose and for positioning it. Preferably, the hose is pressed against an inner wall of the grommet by the insert, whereby it is held resiliently in the sleeve and is not pushed out of the grommet even when pushed onto the pipe socket.

In a further advantageous embodiment of the quick-release hose coupling, the first coupling part has at least two protruding pipe sockets as line ends and the second coupling part has at least two hoses, into the end of each of which a tubular insert is inserted, with one of the pipe sockets being inserted into one of the hoses. Accordingly, at least two grommets for receiving and positioning the hoses are preferably present. In a further preferred embodiment, the at least two grommets are formed in a common hose block arranged in a front section of the second coupling part. The quick-release hose coupling can be used to connect and disconnect several hoses. The basic principle can easily be extended to a plurality of hoses, since a simple sliding movement is required for connection, which is then carried out synchronously on all pipe sockets or hoses.

In another advantageous embodiment of the quick-release hose coupling, the first and second coupling parts have guide elements that guide the two coupling parts linearly to each other when coupling. This ensures that the two parts are inserted into each other in the correct position and alignment.

In another advantageous embodiment of the quick-connect hose coupling, the first and second coupling parts have a cooperating locking mechanism. This allows the two coupling parts to be held together in a mechanically secured manner. The locking mechanism can, for example, have a swivel lever that is articulated on one of the two coupling parts and is designed as an angle lever with a handle part and a locking part, with the locking part interacting with a bolt arranged on the other of the two coupling parts. Preferably, the locking part has a cam track in which the bolt is guided, the cam track being shaped in particular so that when the swivel lever is pivoted shut, the two coupling parts are pulled towards one another. It is also advantageous that a recess is formed in the cam track, in which the bolt is located when the coupling parts are coupled. A tensile force acting externally on the second coupling part, or forces occurring between the hoses and the pipe sockets, act through the recess to close the swivel lever, so that it is pressed into the swung-in position by tensile forces and not swung open.

In addition, the swivel lever can be provided with a latch and/or a lock in predetermined pivot positions. The latch and/or lock further reduces the risk of unintentional decoupling.

### BRIEF DESCRIPTION OF THE DRAWING FIGURES

The invention will be explained in more detail below, with reference to an example, with the help of figures. The figures show:

FIG. 1a, b a quick-release hose coupling in each case in a spatial representation from two different viewing directions;

FIG. 1c a side view of the quick-release hose coupling of FIG. 1a, b;

FIG. 2 a spatial representation of a first coupling part of the quick-release hose coupling of FIG. 1a-c;

FIG. 3a, b each a spatial representation of a second coupling part of the quick-release hose coupling of FIG. 1a-c;

FIG. 4a a three-dimensional sectional view of a hose block of the quick-release hose coupling coupling of FIG. 1a-c;

FIG. 4b a sectional view of the hose block of the quick-release hose coupling of FIG. 1a-c;

FIG. 5a-c side views of the second coupling part of the quick-release hose coupling of FIG. 1a-c in different pivoting positions of a swivel lever; and

FIG. 6 a side view of the second coupling part similar to FIG. 5a-c, but without the swivel lever.

### DETAILED DESCRIPTION

The figures described below show an example of a quick-release hose coupling that is used to quickly connect or disconnect six hoses. It should be noted that this number is purely exemplary and that the quick-release hose coupling can also be adapted to a smaller or larger number of hoses that are to be connected or disconnected.

The illustrated quick-release hose coupling is suitable for use in milking technology. Four milk-carrying hoses and two further hoses are connected or disconnected. The other hoses may, for example, carry vacuum and a cleaning liquid. It is understood that the illustrated quick-release hose coupling can also be used in other areas of application.

In all figures, the same reference signs identify the same elements. For reasons of clarity, not all figures show all elements with reference signs.

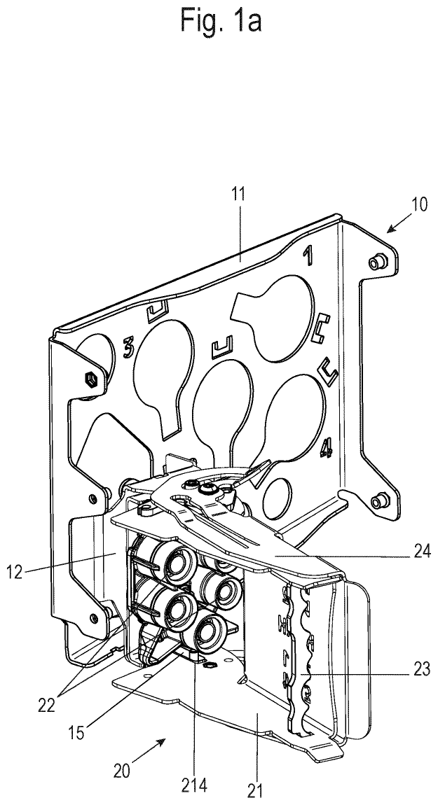

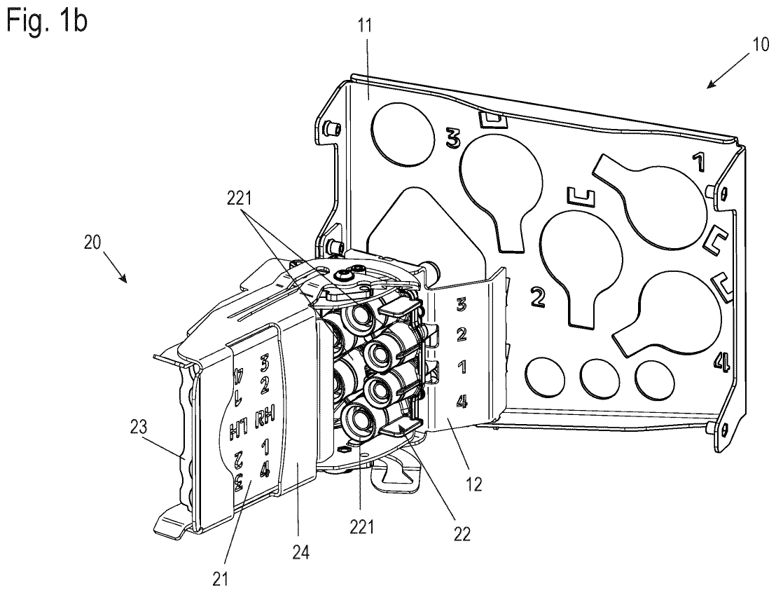

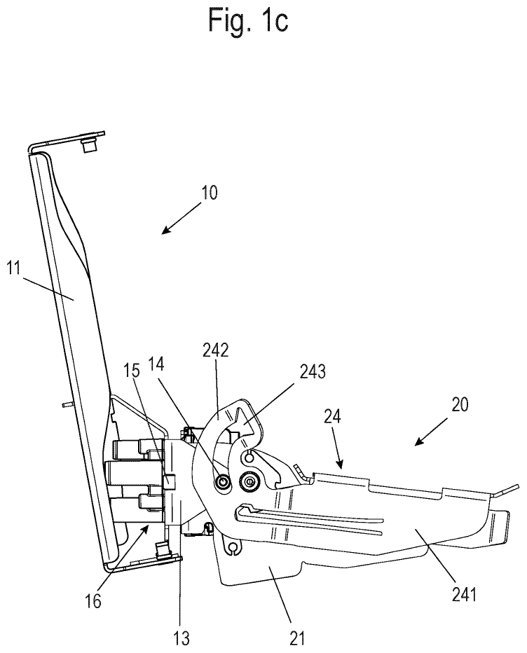

FIGS. 1a and 1b show the quick-release hose coupling in a spatial representation from two different perspectives. FIG. 1c shows a side view of the quick-release hose coupling.

The quick-release hose coupling has two coupling parts, a first coupling part 10 and a second coupling part 20. In the example shown, the first coupling part 10 is designed as a permanently installed coupling part in, for example, a milking parlor. It includes a mounting plate 11, which in the present case provides mounting options for valves or similar components that are not part of the quick-release hose coupling. In other configurations, the mounting plate 11 can be smaller and without the additional mounting options for further components. It is also conceivable that the first coupling part is not designed for fixed installation in a system.

A desk 12 is mounted on the mounting plate 11, which carries a block of pipe sockets 16, from which at least one, in this case six, pipe sockets 17 protrude—one of the pipe sockets 17, respectively, for each hose of the quick-release hose coupling to be disconnected.

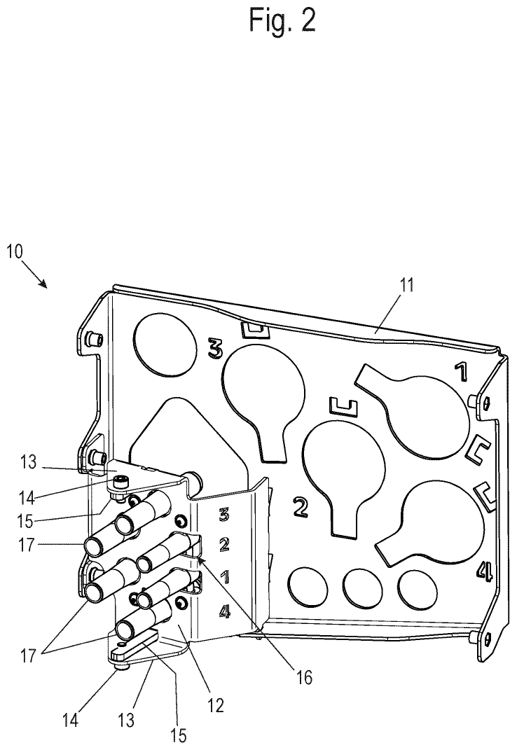

The pipe sockets 17 are easily recognizable in FIG. 2, in which the first coupling part 10 is shown separately in three dimensions without the second coupling part 20 placed on it. In addition to the protruding pipe sockets 17, the desk 12 has folded side panels 13, in each of which a bolt 14 is arranged. The bolts 14 are used for the mechanical locking of the second coupling part 20, as will be explained in more detail below. The rear ends of the pipe sockets 17, pointing in the direction of the mounting plate 11, are connected to lines on the system side. The lines on the system side may be hoses or pipes.

The second coupling part 20 is designed here as a detachable coupling part, to which hoses are attached that lead, for example, to a milking cluster. The quick-release hose coupling makes it possible to disconnect this second coupling part 20 and thus, for example, the milking cluster, from the first coupling part 10 with little effort, whereby the six lines shown here are disconnected. For mechanical guidance when the two coupling parts 10, 20 are joined together, the first coupling part 10 is provided with guide ridges 15 and the second coupling part 20 is provided with guide grooves 214, which engage with each other and form a kind of linear guide. In this way, the two parts are inserted into each other in the correct position and alignment. In the present embodiment, the bolts 14 are screw heads of screws that are screwed into the guide ridges 15 located on the other side of the side panel 13, which are thus attached at one of their ends in each case. The other end of the guide ridges 15 is attached to the desk 12 by being inserted into a recess.

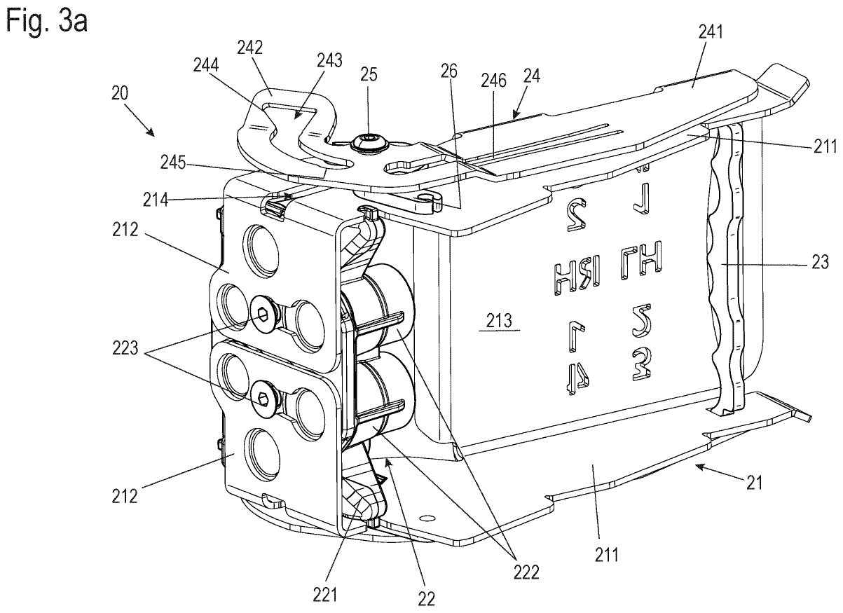

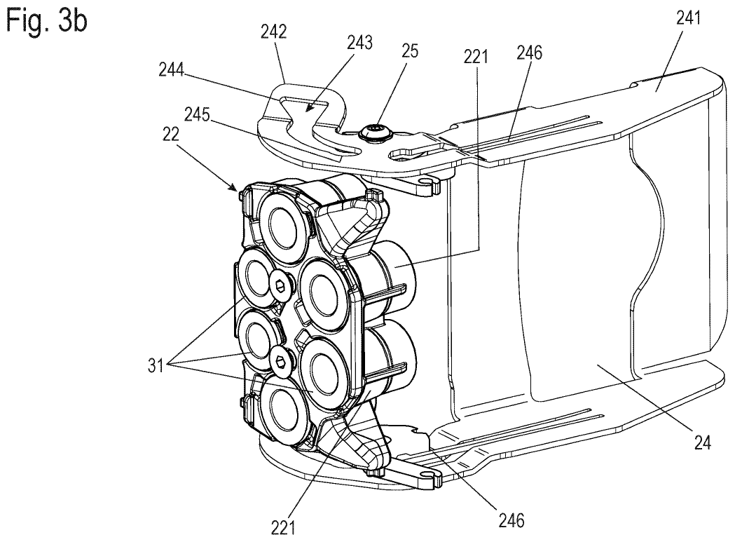

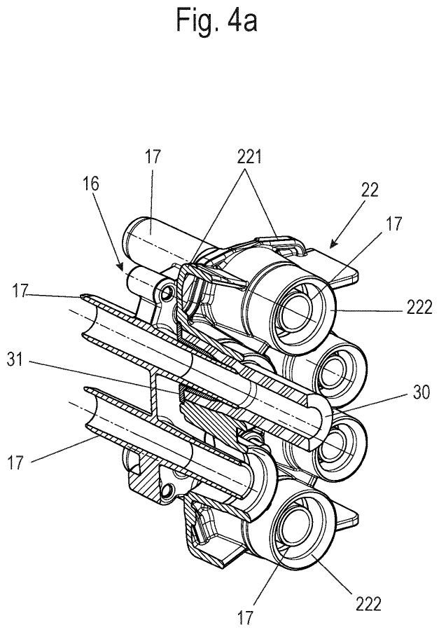

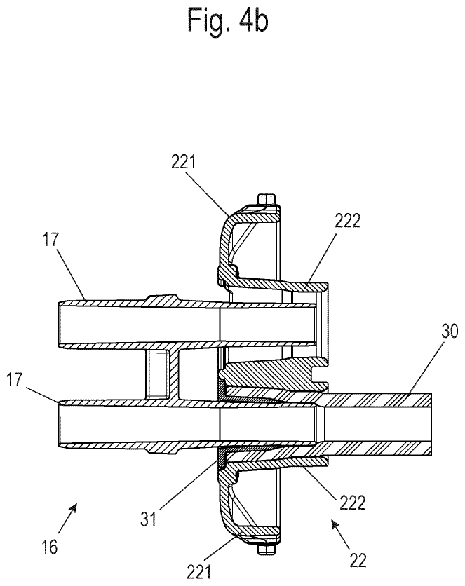

The second coupling part 20, which is shown in FIG. 3a separately from the first coupling part 10 in a spatial representation, has a u-shaped carrier 21, which is made, for example, from sheet metal as a stamped and bent part. The carrier 21 comprises a base plate 213 and side walls 211. These are folded in a front section facing the first coupling part 10, thus forming two front plates that together form a front 212. It is noted that this front 212 can also be formed in one piece by a continuous plate. Behind the front 212, a hose block 22 is arranged, which can be inserted laterally into the carrier 21 and can be fastened by means of screws 223 from the side of the front 212. Hoses are mounted on this hose block 22, as will be explained in more detail in connection with FIGS. 4a and 4b. The hoses are then routed well protected in the U-shaped carrier 21, with a hose clamp 23 being inserted in the rear area of the carrier 21, with the aid of which the hoses are fixed in the carrier 21. The hose clamp 23 also serves as a strain relief so that the hoses cannot be pulled out of the hose block 22.

A swivel lever 24, which is also u-shaped, is attached so that it can rotate around a pivot axis 25, encompassing the carrier 21 from one side. The pivot axis 25 is formed by bolts or screws that are mounted in the side wall 211, for example, by being screwed in.

The swivel lever 24 is designed as an angle lever and has a handle part 241 and a locking part 242. The locking part 242 is provided with a recess 243. To couple the first and second coupling parts 10, 20, the second coupling part 20 is placed with the pivoted swivel lever 24 on the first coupling part 10. A front end of the respective locking part 242 is angled outwards and the recess 243 is widened in each case. This forms two catch funnels 244 through which the bolts 14 of the first coupling part 10 can be inserted into the recess 243. The handle 241 is then pivoted to the base plate 213 of the carrier 21, causing the edge of a cam track of the recess 243 to grip the bolt 14 on both sides of the coupling parts 10, 20 and to draw the second coupling part 20 towards the first coupling part 10. The swivel lever 24 and the bolts 14 thus work together in the manner of a locking angle lever. The guide grooves 214 and the guide ridges 15 absorb any lateral forces that arise from the locking movement.

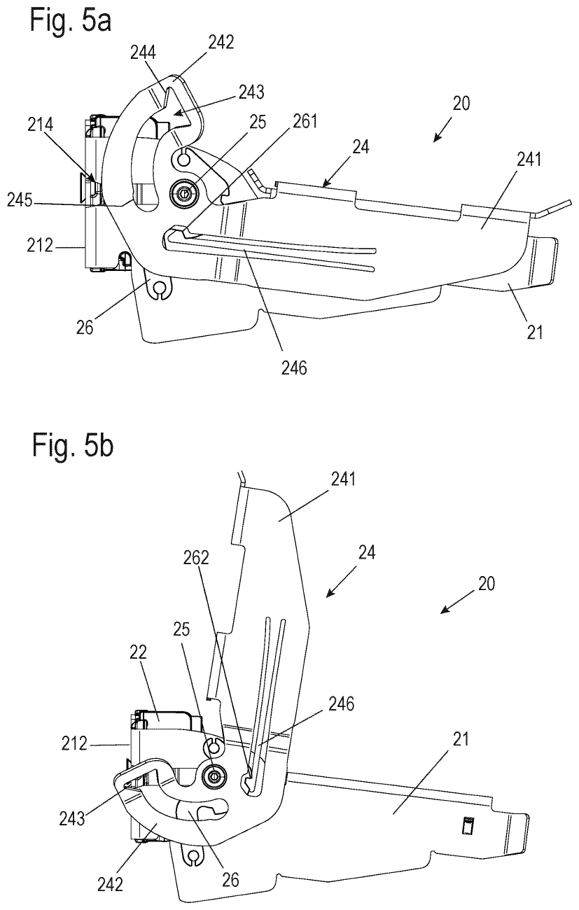

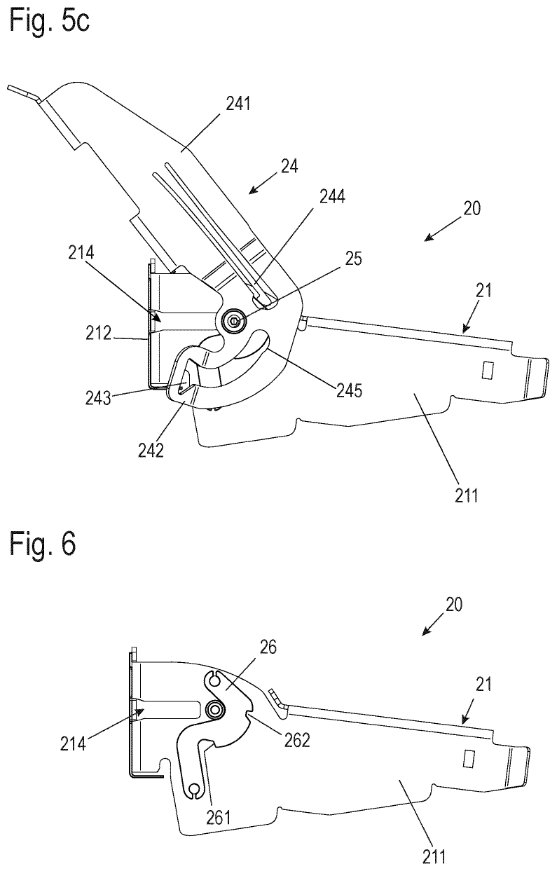

FIG. 3b shows the structure of the second coupling part 20 in the same way as in FIG. 3a, but with the carrier 21 hidden, in order to clarify the structure. In the handle part 241 of the swivel lever 24, latching tongues 246 are punched out, which prevent unintentional disengagement of the second coupling part 20 from the first coupling part 10. This functionality will be explained in more detail in connection with FIGS. 5a to 5c and 6 below.

FIGS. 4a and 4b show the hose block 22 separately in more detail and illustrate the positioning of a hose 30 in the hose block 22 and thus the sealing principle of the quick-release hose coupling. FIG. 4a shows the hose block 22 in a spatial partially cut view together with a correspondingly cut section of the pipe socket block 16 of the first coupling part 10. The positioning of the pipe socket block 16 and the hose block 22 corresponds to the positioning in the coupled state of the two coupling parts 10, 20. In FIG. 4b, the sectional area from FIG. 4a is again shown in a side view of the cut hose block 22.

The hose block 22 has a carrier 221 in which a plurality of grommets 222 are formed. The grommets 222 correspond in number and positioning to the pipe sockets 17 of the pipe socket block 16. In other words, a pipe socket 17 and a grommet 222 are located on a common center axis.

For example, a hose 30 is mounted in the hose block 22 only on one of the grommets 222. To assemble the hose 30, one free end of the hose is inserted into the grommet 222 from the rear side pointing towards the hose clamp 23. From the front side of the grommet 222, an insert 31 is then pushed into the end of the hose, which spreads the hose 30 in this area and presses it against an inner surface of the grommet 222. In the example shown, the insert 31 is slightly funnel-shaped. At its front end inserted into the hose 30, a wall thickness of the insert 31 tapers so that almost no transition is formed between the end of the insert 31 and that of the inside of the hose 30.

The insert 31 is used to secure the respective hose in the grommet 222, whereby, by sliding the hose block 22 into the carrier 21, the collar of the insert 31 is held against the inside of the front 212 and is thus prevented from slipping out of the respective grommet 222 or the respective hose 30.

To connect all the hoses 30 to be disconnected or connected by the quick-release hose coupling, they are inserted into the respective grommet 222 in the removed hose block 22 and fixed by inserting an insert 31 in each case. The hose block 22 with the connected hoses 30 is then inserted into the carrier 21 and the hoses 30 are additionally secured by the hose clamp 23.

As can be seen in FIGS. 4a and 4b, when the second coupling part 20 is placed on the first coupling part 10, the pipe sockets 17 are guided through the inserts 31, with the pipe sockets 17 being length dimensioned so that when the second coupling part 20 is fully mounted, they project out of the insert 31 and an annular section of their outer lateral surface is in direct contact with a circumferential section of the inner surface of the respective hose 30. At this point, a circumferential seal is formed between the hose 30 and the respective pipe socket 17 due to the elasticity of the hose 30. An additional seal, which would have to be maintained or replaced regularly, is not required. In addition, further potential dead volumes in the area of a separate seal are avoided.

FIGS. 5a to 5c show the second coupling part 20 in a side view in different swivel positions of the swivel lever 24. FIG. 6 shows the second coupling part 20 without the swivel lever 24 in a side view comparable to that of FIGS. 5a-c for further explanation of the structure.

In order to prevent the second coupling part 20 from accidentally disengaging from the first coupling part 10, the swivel lever 24 is equipped with a latching and locking mechanism. For this purpose, the latching tongue 246 is stamped out of the handle part 241 on at least one side, which interacts with a latching plate 26, which can be seen in FIG. 6 and which is attached to the side wall 211 of the carrier 21. The latching plate 26 has latching recesses 261 and 262, in which the latching tongue 246 of the swivel lever 24 engages in corresponding rotational positions.

When the swivel lever 24 is pivoted in, i.e., in a position in which the first and second coupling parts 10, 20 are connected to one another, the latching tongue 246 engages with its latching hook, which is arranged at the front end, in the latching recess 261. The contact edge of the latching recess 261, against which the latching hook rests, is slightly slanted so that the swivel lever 24 is held in the pivoted-in position, but when a sufficient actuating force is applied, the latching hook lifts out of the latching recess 261 and the swivel lever 24 can be pivoted open.

This latching function prevents the swivel lever 24 from being pivoted up too easily and thus possibly being pivoted up accidentally. In addition, the recess 243 has an indentation 245 at its end opposite the catch funnel 244, in which the bolt 14 is located when the lever 24 is pivoted in. A tensile force acting externally on the second coupling part 20 or forces occurring between the hoses 30 and the pipe sockets 17 act through the indentation 245 in a self-closing manner on the swivel lever 24, i.e., the latter is pressed by tensile forces into the swung-in position and not swung open.

It can be swung open by hand up to the position shown in FIG. 5b. In this position, the latching hook of the latching tongue 246 engages in the wider latching recess 262. In this position, the two coupling parts 10, 20 can be disconnected from each other. The shape of the further recess 262 is such that the swivel lever 24 cannot pivot any further. The latching tongue 246 and the further recess 262 act as a stop in the direction of further pivoting.

FIG. 5c shows an assembly position of the swivel lever 24. The shape of the latching plate 26 is such that the latching tongue 246 is not prestressed in this pivoted position. This makes it easy to mount the swivel lever 24 on the carrier 21 in this position. After assembly, the pivot lever is pivoted in, whereby the latching tongue 246 is prestressed and latches into the further latching recess 262 according to FIG. 5b. For the subsequent use of the second coupling part 20, the pivot lever is then only pivoted between the positions shown in FIGS. 5a and 5b by the user.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### List of Reference Signs

10 first coupling part (fixed)
11 mounting plate
12 desk
13 side panel
14 bolt
15 guide ridge
16 pipe socket block
17 pipe socket
20 second coupling part (detachable)
21 carrier (U-shaped)
211 side wall
212 front
213 base plate
214 guide groove
22 hose block
221 carrier
222 grommet
223 screw
23 hose clamp
24 swivel lever
241 handle
242 locking part
243 recess
244 funnel
245 indentation
246 latching tongue
25 pivot axis
26 latching plate
261 latching recess
262 further latching recess
30 hose
31 insert

1-16. (canceled)

17. A quick-release hose coupling configured to connect and disconnect at least two line ends of lines for liquid or gaseous media, the quick-release hose coupling comprising:
a first couplable coupling part comprising at least one protruding pipe socket as a first one of the at least two line ends; and
a second couplable coupling part configured to be mechanically coupled to the first couplable coupling part, wherein the second couplable coupling part comprises at least one hose as a second one of the at least two line ends, and wherein a tubular insert is inserted into the second one of the at least two line ends,
wherein when the first and second couplable coupling parts are coupled, the at least one protruding pipe socket of the first couplable coupling part is guided through the tubular insert of the second couplable coupling part and projects beyond the tubular insert in a hose direction of the at least one hose, and
wherein a sealing surface is formed between an outer lateral surface of the at least one pipe protruding socket and an inner surface of the at least one hose.

18. The quick-release hose coupling of claim 17, wherein an inside diameter of the tubular insert reduces in the hose direction.

19. The quick-release hose coupling of claim 17, wherein an external diameter of the tubular insert decreases in the hose direction.

20. The quick-release hose coupling of claim 17, wherein the tubular insert has an outwardly projecting collar towards an end of the tubular insert pointing against the hose direction.

21. The quick-release hose coupling of claim 17, wherein a wall thickness of the tubular insert decreases towards an end of the tubular insert pointing in the hose direction.

22. The quick-release hose coupling of claim 17, wherein the second couplable coupling part has at least one grommet configured to receive and position an end of the at least one hose.

23. The quick-release hose coupling of claim 22, wherein the at least one hose is pressed against an inner wall of the at least one grommet by the tubular insert.

24. The quick-release hose coupling of claim 17, wherein the at least one protruding pipe socket includes at least two protruding pipe sockets, wherein the at least one hose comprises at least two hoses, wherein the tubular insert comprises at least two tubular inserts, wherein a respective one of the at least two tubular inserts is inserted into a respective one of the at least two hoses, and wherein a respective one of the at least two protruding pipe sockets is introduced into a respective one of the at least two hoses.

25. The quick-release hose coupling of claim 24, further comprising:
at least two grommets, wherein a respective one of the at least two hoses is inserted into a respective one of the at least two grommets.

26. The quick-release hose coupling of claim 25, wherein the at least two grommets are formed in a common hose block arranged in a front section of the second couplable coupling part.

27. The quick-release hose coupling of claim 17, wherein the first and second couplable coupling parts each have guide elements that guide the first and second couplable coupling parts linearly relative to each other during coupling.

28. The quick-release hose coupling of claim 17, wherein the first and second couplable coupling part have a co-operating locking mechanism.

29. The quick-release hose coupling of claim 28, wherein the co-operating locking mechanism has a swivel lever articulated on one of the first and second couplable coupling parts and is an angle lever with a handle part and a locking part, wherein the locking part is configured to interact with a bolt arranged on the other of the first and second couplable coupling parts.

30. The quick-release hose coupling of claim 29, wherein the locking part has a cam track in which the bolt is guided.

31. The quick-release hose coupling of claim 30, wherein the cam track has a recess in which the bolt is located when the first and second couplable coupling parts are coupled.

32. The quick-release hose coupling of claim 29, wherein the swivel lever is configured to latch or lock in predetermined pivot positions.
